(19) United States
(12) Patent Application Publication
(10) Pub. No.: US 2015/0375251 A1
(43) Pub. Date: Dec. 31, 2015

(54) METHOD FOR OPERATING A SURFACE TREATMENT SYSTEM

(71) Applicant: EISENMANN AG, Böblingen (DE)

(72) Inventor: Juergen Roeckle, Magstadt (DE)

(73) Assignee: Eisenmann SE, Boeblingen (DE)

(21) Appl. No.: 14/766,532

(22) PCT Filed: Jan. 15, 2014
(86) PCT No.: PCT/EP2014/000083

§ 371 Date: Aug. 7, 2015

(30) Foreign Application Priority Data
Feb. 7, 2013 (DE) 10 2013 002 041.7

(51) Int. Cl. B05B 15/12; F23G 5/033; F23G 5/04; B01D 46/42

(52) U.S. Cl. CPC B05B 15/1225; B01D 46/42; F23G 5/033; F23G 5/04; B05B 15/1248

(57) ABSTRACT

The invention relates to a method for operating a surface treatment system in which overspray, which is generated in one or several coating booths, is picked up by an air stream and is guided to one or more one-way separation units in which the overspray is separated, said units being respectively exchanged, after reaching an overspray charge limit, as charged one-way separation units with an empty one-way separation unit. Said charged one way separation units are used to produce a treatment material which enables a later valuation.

The invention relates to a method for operating a surface treatment plant, in which overspray arising in one or more coating booths is picked up by an air stream and guided to one or more disposable separating units, in which overspray is separated and which are respectively exchanged, after reaching a limit loading with overspray, as laden disposable separating units, for an empty disposable separating unit.

During the manual or automatic application of paints to objects, a partial flow of the paint, which generally contains both solids and/or binders as well as solvents, is not applied to the object. This partial flow is called “overspray” among experts. Hereinbelow, the terms overspray, overspray particles or overspray solids are always to be understood in the sense of a disperse system, such as an emulsion or suspension or a combination thereof. The overspray is picked up by the air stream in the painting booth and passed on for a separation, so that the air can be led back into the coating booth again, optionally after a suitable conditioning.

Particularly in plants with relatively high paint consumption, for example in plants for painting vehicle bodies, in a known manner preferably wet separating systems are used on the one hand or electrostatically operating dry separators on the other hand. In the case of known wet separators, a relatively large amount of energy is needed to circulate the quite large amounts of water required. The processing of the rinsing water is costly due to the high use of paint-binding and -detackifying chemicals and due to the disposal of paint sludge. Furthermore, the air takes up a very large amount of moisture due to the intensive contact with the rinsing water, which in the circulating-air operation once again results in high energy consumption for the air processing. In the case of electrostatically operating dry separators, the paint overspray must be removed continuously from the separating surfaces, which in most cases involves structurally quite complex measures and may accordingly be susceptible to trouble. In addition, the energy expenditure in such separators is relatively high.

As an alternative to conventional, stationary wet and dry separating systems, which may also operate electrostatically, systems having exchangeable disposable separating units are also used, which after reaching a limit loading with overspray are exchanged for unladen filter modules and disposed of or optionally recycled. The processing and/or disposal of such separating units may be more compatible energetically and also with regard to the required resources than the expenditure in a wet separator or an electrostatically operating separating device.

Usually the resulting, laden disposable separating units are immediately comminuted and then, depending on the kind of overspray taken up, disposed of in a landfill or incinerated in an incineration plant.

It is the object of the invention to improve the utilisation process of the laden separating units.

This object is achieved in a method of the kind mentioned at the outset in that a processing material is produced from laden disposable separating units, which material enables subsequent utilisation. Utilisation is understood in the present case to mean on the one hand an exploitation, such as for example an incineration, in which the energy can be recovered, or the use as an additive for other materials which are to be processed, but on the other hand also a landfill disposal.

The invention is based on the insight that, from the point of view of energy and with regard to the resource compatibility, it is sensible firstly to treat the laden separating units and from these produce a modified processing material, which is then landfilled or passed on for valuable substance utilisation. Such a processing material may, for example, have a heating value which is higher than the untreated laden separating units to such an extent that the energy balance is improved despite the treatment steps required.

In this case it may be favourable when the processing material is produced in a processing plant which is associated with the surface treatment plant. As a result of this, in particular short transporting distances are possible and the processing can be performed by the operator of the surface treatment plant.

Alternatively, it may be advantageous when the processing material is produced in a processing plant which is not associated with the surface treatment plant. In this case, the processing plant can be operated by a third-party provider engaged by the operator of the surface treatment plant to carry out the processing.

Frequently, surface treatment plants comprise a plurality of coating booths, in which different kinds of overspray arise. Vehicle bodies for example are coated in different coating booths with a primer, a base coat and a top coat. In this case, it may alternatively be favourable that
a) laden disposable separating units are jointly processed in the processing plant, irrespective of the kind of overspray with which they are laden;
or
b) laden filter modules which come from one and the same or from the same kind of coating booths are in each case jointly processed, so that the jointly processed filter modules are laden with overspray of the same kind and a segregated processing material based on the kind of overspray is obtained.

The respective procedure is selected depending on the kind of overspray, but also depending on the kind and the material properties of the disposable separating units.

If the processing is carried out according to the above step b), it may be advantageous when different segregated processing products are brought together to form a mixed processing material. This mixed processing product can then again either be landfilled or passed on for valuable substance utilisation.

It is particular favourable when the processing material is passed on for thermal utilisation.

Preferably, the thermal utilisation is performed by incinerating in an incineration plant.

With regard to the method efficiency, it is advantageous when the incineration plant is associated with the surface treatment plant.

In particular in this case, energy which is recovered in the thermal utilisation can be used to operate the surface treatment plant and/or the processing plant.

In the production of the processing material from laden disposable separating units, preferably one or more of the following steps are carried out:
a) drying of the laden separating units;
b) coarse comminuting or reducing in size of the laden separating units to form filter parts or filter packages;
c) shredding of the laden separating units or of filter parts or of filter packages to form coarse shredded material or to form fine shredded material;
d) admixing additives in one or more of the above steps a), b) or c).

These steps can be carried out alone or in combination with one another, it also being possible to change the order. The admixing of additives will be discussed further hereinbelow.

Exemplary embodiments of the invention are explained in more detail below with reference to the drawings, in which:

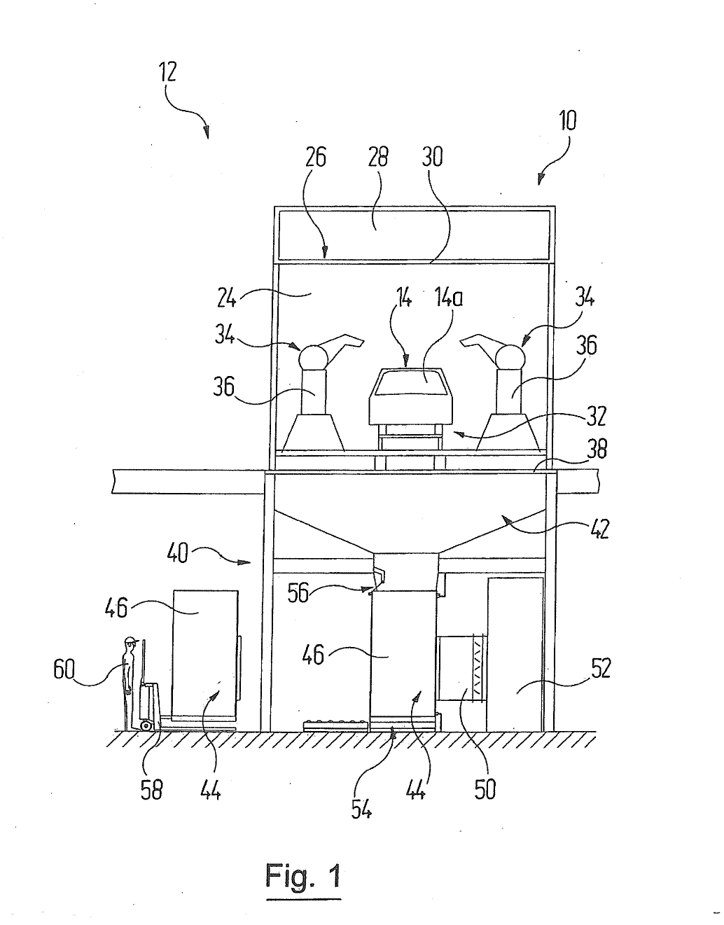

FIG. 1 shows, in a front view, a painting booth having a separating device for overspray according to a first exemplary embodiment, in which overspray-laden booth air is led to disposable filter modules;

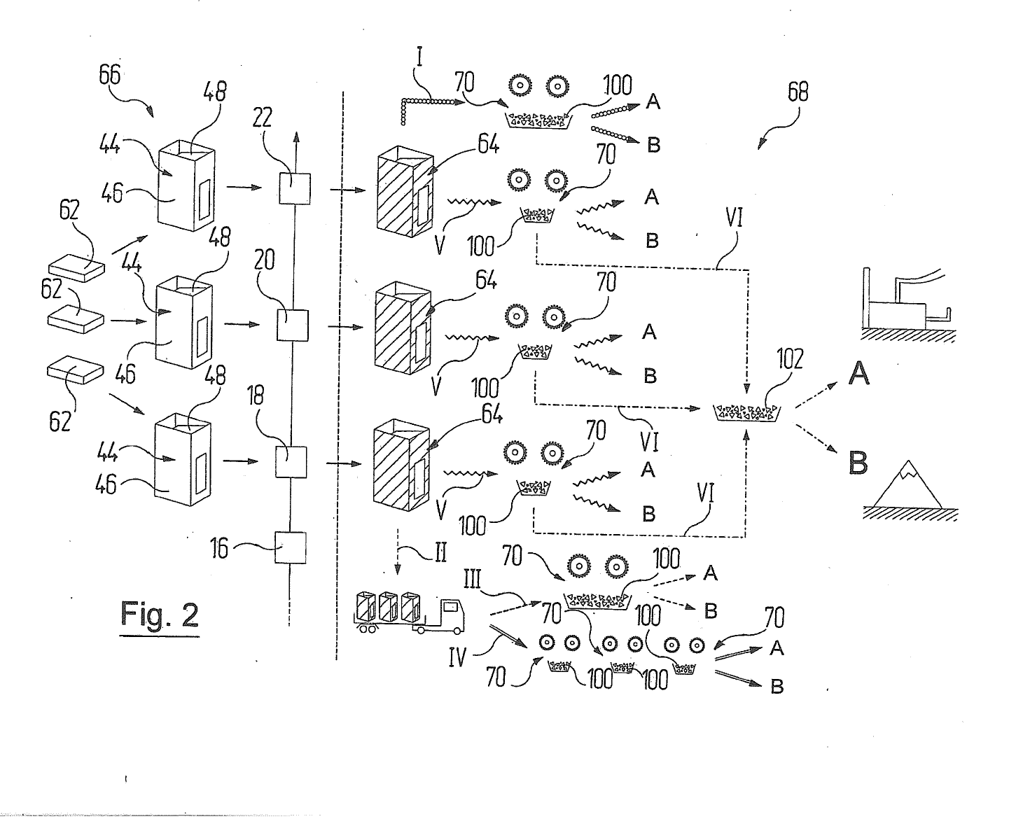

FIG. 2 shows an overview diagram, in which the use of filter modules and various utilisation methods for laden filter modules are illustrated;

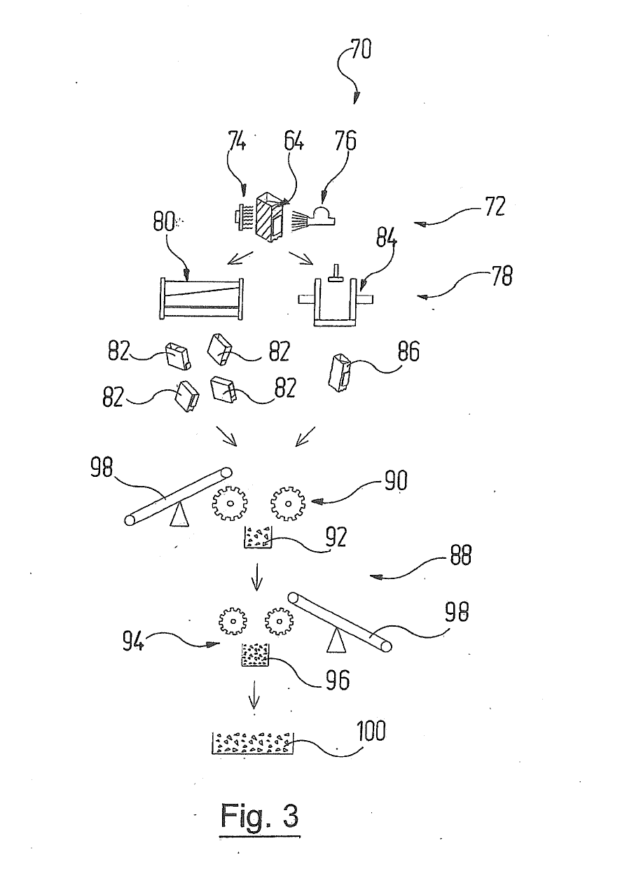

FIG. 3 shows, schematically, different treatment stations in a processing plant, in which laden filter modules can be subjected to a treatment and which promote the utilisation.

In FIG. 1, numeral 10 designates as a whole a coating booth of a surface treatment plant 12, in which objects 14 are painted. Vehicle bodies 14a are shown as an example of objects 14 to be painted. Before reaching such a coating booth 10, they have been for example cleaned and degreased in pretreatment stations 16, one of which is shown schematically in FIG. 2.

After this, the vehicle bodies 14a are provided in successive coating stations 18, 20 and 22 with a primer, a base coat and a top coat, as is known per se. For this, in each coating station 18, 20, 22 there is arranged a coating booth 10, in which the respective coating material is applied to the vehicle body 14a.

In each treatment booth 10 of the different treatment stations 18, 20 and 22 different kinds of overspray arise, i.e. generally speaking the surface treatment plant 12 comprises a plurality of coating booths 10, in which different kinds of overspray arise.

The coating booth 10 has a coating tunnel 24 arranged at the top, with a ceiling 26 which is formed customarily as a lower delimitation of an air supply space 28 with filter ceiling 30.

The vehicle bodies 14a are transported by a conveying system 32, accommodated in the coating tunnel 24 and known per se, from the entrance side of the coating tunnel 24 to its exit side. Situated inside the coating tunnel 24 are application devices 34 in the form of multi-axis application robots 36, as are likewise known per se. By means of the application robots 36 the vehicle bodies 14a can be coated with the corresponding material.

Downwardly the coating tunnel 24 is open, via a walk-on grating 38, towards a plant region 40 arranged therebelow, in which overspray particles carried along by the booth air are separated from the booth air.

During the coating process, air flows from the air supply space 28 downwards through the coating tunnel 24 to the plant region 40, the air picking up and carrying along paint overspray present in the coating tunnel 24.

This overspray-laden air is led with the aid of an air guiding device 42 to a plurality of disposable separating units 44, which are formed in the present exemplary embodiment as disposable filter modules 46. Reference is made below to filter modules, the statements regarding which apply analogously to disposable separating units 44 generally, which units may also be formed differently to the filter modules 46 described.

Each filter module 46 may be formed in a manner known per se, for example, as a separating filter or as an inertial filter or as a combination thereof.

In operation each filter module 46 is fluidically and detachably connected to the air guiding device 42. The booth air flows in the filter module 46 through a filter unit 48, on which the paint overspray is deposited. The filter unit 48 can be seen only in the filter modules 46 shown in perspective in FIG. 2. Each disposable separating unit 44 as a whole is formed as an exchangeable unit.

The booth air, now largely freed from overspray particles, flows out of the filter module 46 into an intermediate duct 50, via which it passes into a collecting flow duct 52. The booth air is passed on, via the collecting flow duct 52, for further processing and conditioning and following that is led in a circuit (not shown specifically here) into the air supply space 28 again, from which it again flows from above into the coating tunnel 24. If the booth air is not yet sufficiently freed from overspray particles by the filter modules 46 present, there can be arranged downstream of the filter modules 46 still further filter stages, to which the booth air is supplied and in which, for example, nonwoven filters or electrostatically operating separating filters are inserted, as are known per se. Optionally, one or more such further filter stages can also be integrated in the filter module 46.

In its operating position the filter module 46 rests on scales 54 and is locked in its operating position by means of a locking device 56. In the present exemplary embodiment, the filter module 46 can be fluidically connected to the air guiding device 42 or detached therefrom by being moved in the horizontal direction. Generally, however, the coupling and uncoupling movement depends on the interaction of the components.

Each filter module 46 is designed for taking up a maximum amount of paint, i.e. for a limit loading with overspray, which depends on the design of the filter module 46 and the materials used for the latter. The amount of paint already taken up can be monitored via the scales 54. Alternatively, the limit loading can be ascertained by means of a differential pressure determination. The greater the loading of the filter module 46, the greater is the air resistance created by the filter module 46.

When a filter module 46 reaches its maximum take-up capacity, the locking device 56 is released and the fully laden filter module 46 is moved out of the lower plant region 40 of the coating booth 10. This can be performed, for example, with the aid of a lift truck 58 which is operated by a worker 60. For this, the bottom region of the filter module 46 can be formed in its geometry and its dimensions as a standardised supporting structure and, for example, according to the specification of a so-called Euro-pallet.

Prior to this the flow connection, to the air guiding device 42, of the filter module 46 to be exchanged is closed by means of a slide gate (not shown specifically). Then an empty filter module 46 is pushed into the operating position, in which it is connected flow-tightly to the air guiding device 42, whereupon the locking device 54 is locked again. The slide gate of the air guiding device 42 is brought into an open position again, so that the booth air flows through the newly positioned filter module 46.

The disposable filter module 46 can be produced as a whole, including its filter unit 48, from a wet-strength recycling material. Generally speaking, one component, a plurality of components or all the components of the filter module 46 can be produced from a wet-strength recycling material. Example of possible materials for this are cellulose materials such as optionally treated paper materials and paperboard materials, corrugated cardboard, cardboards with vertical fluting, cardboards with honeycomb structure or tube boards, but also other materials, such as e.g. MDF materials. The bottom region of the filter module 46 can also be formed separately by a Euro-pallet made of wood. Plastics such as in particular polyethylene or polypropylene are also possible.

The filter module 46 itself can also be supplied as a modular kit in individual parts and assembled at the site of the surface treatment plant 12. For example, a filter module 46 can also be designed such that it can be unfolded from a folded-up configuration. A filter module kit has a volume which can be considerably smaller than the volume of the unfolded or assembled disposable filter modules 46. This is illustrated in FIG. 2 by filter module kits 62.

In the following, reference is now made to FIG. 2 which illustrates the use of the filter module kits 62 or the filter modules 46, and various utilisation methods for laden separating units or filter modules, which bear the reference symbol 64 there. The procedure there is divided into a use phase 66 of the filter modules 46 and a utilisation phase 68 of the laden filter modules 64, which are shown separated from one another by a dashed line in FIG. 2.

In the use phase 66, filter module kits 62 or alternatively already usable filter modules 46 can be brought to the surface treatment plant 12 or to the coating booth 10 in which the filter modules 46 are to be used. In the case of the filter module kits 62, the filter modules 46 are produced therefrom on site and then used in the above-described manner in the coating booths 10 of the coating stations 18, 20 and 22.

The laden filter modules 64 resulting after reaching the limit loading and removed from the respective coating booth 10 are then utilised in the utilisation phase 68, for which various methods are possible. The laden filter modules 64 are laden with different kinds of overspray depending on the treatment booth 10 from which they come.

In FIG. 2, by way of example a total of six utilisation methods I, II, III, IV, V and VI are shown, each utilisation method being respectively assigned arrows of the same kind.

In each utilisation method I to VI, the laden filter modules 64 are subjected in a processing plant 70 to a processing treatment, in order to produce a processing material which enables a subsequent utilisation. This is therefore explained firstly with the aid of FIG. 3, which illustrates the processing plant 70 with exemplary processing stations.

The laden filter modules 64 are dried in a drying station 72. Drying here means all processes in which the taken-up overspray can be caused to harden, whether this is by expulsion of solvents or by crosslinking of the coating substance. For this the overspray can, for example, be gelled using electromagnetic radiators 74 or heat-treated with hot air by means of blowers 76.

The filter modules 64 are coarsely comminuted or reduced in size in a comminution station 78. This can be performed, for example, by a cutting device 80, in which the individual filter modules 64 are cut up into smaller filter parts 82. Alternatively, the filter modules 64 can, for example, be compressed in a pressing device 84 to a smaller filter package 86.

The filter modules 64 or filter parts 82 or the filter packages 86 can be processed in a shredding station 88 with the aid of a coarse shredding device 90 to form coarse shredded material 92 and optionally processed with the aid of a fine shredding device 94 to form fine shredded material 96.

Additives can be admixed here in each case, in order to change and to influence the consistency of the shredded material 92 or 96 or its properties, in particular its heating value. This is indicated in each case by a conveyor belt 98. Thus, for example, stone and wood materials in the form of flours, powders or dusts can be added both as binders and to increase the heating value. The material of the filter modules 64 can also be used as support material for pastes or liquids which arise in other places as waste products and are to be disposed of or burnt, and the further treatment of which is made more difficult due to their consistency, which is pasty or liquid.

The treatment stations 72, 78, 88 explained are intended merely as examples and also represent processing treatments not specifically explained, of which all, only some or only one can be performed depending on the filter modules 64 and the overspray taken up by the latter.

By means of the processing plant 70 there is obtained a processing material 100 which may have different physical properties to the starting material in the form of the laden filter modules 64. For example, owing to the treatments, the volume, the density, the structure, the consistency and/or the moisture and the like have been changed and optionally adjusted in a specific manner.

The chemical properties of the processing material 100 may also have been changed compared with the laden filter modules 64. In particular, properties such as combustibility, flash point, pH-value, adhesiveness and the like may be mentioned here.

During the production of the processing material 100 it can also be ensured that the processing material 100 is storable, so that downstream of the processing plant 70 the processing material 100 can firstly be temporarily stored and optionally collected.

For example, the processing material 100 obtained can be designed for landfill disposal or thermal utilisation. A landfill disposal of the material is illustrated in FIG. 3 by a landfill designated by the letter A, whereas an incineration plant B illustrates a thermal utilisation. A separation and isolation of the individual components by the processing plant 70 is also conceivable, so that suitable components of the laden filter modules 64 can be recycled and supplied to a valuable substance loop. In this case, the remaining components which are not reusable or further usable are landfilled or thermally utilised.

In the first utilisation method I shown in FIG. 3, the laden filter modules 64 are subjected to a joint treatment in the processing plant 70, irrespective of the kind of overspray with which they are laden. The coating station 18, 20, 22 from which the laden filter modules 64 come is thus irrelevant.

In this utilisation method I the processing plant 70 is associated with the surface treatment plant 12 and is then expediently operated by the operator of the surface treatment plant 12, so that the use of the filter modules 46 and the processing of the laden filter modules 64 is in the same hands. The incineration plant B can also be operated by the same operator, so that thermal energy recovered can be used to operate the surface treatment plant 12 and/or to operate the processing plant 70 and there to carry out some or all of the processing steps carried out.

In an alternative utilisation method II the laden filter modules 64 are, in contrast, collected for processing and in a further utilisation method III jointly processed in a processing plant 70 which is not associated with the surface treatment plant 70. Optionally, this non-associated processing plant is run by an external operator. The processing material 100 recovered there can again be landfilled or thermally utilised. The thermal utilisation can, in this case too, again be performed in an incineration plant B which belongs to the operator of the surface treatment plant.

In addition to the utilisation method III, a segregated processing based on the kind of overspray is possible in a utilisation method IV. This means that in the non-associated processing plant 70 laden filter modules 64 which come from one and the same or from the same kind of coating booths 10 are in each case jointly processed, so that the filter modules 64 are laden with overspray of the same kind.

This is illustrated in the utilisation method IV by three processing plants 70 which represent the processing of a respective laden filter module 64 which is laden with primer overspray, base coat overspray and top coat overspray, respectively.

Each such segregated processing product 100 obtained can then again be disposed of in the landfill A or alternatively thermally utilised in the incineration plant B, the latter again being able to be assigned to the surface treatment plant 12.

Such a segregated processing of the laden filter modules 64 can be carried out in a utilisation method V also alternatively by the operator of the surface treatment plant 12, this again being illustrated by in each case a separately shown processing plant 70. The processing plant 70 is here again associated with the surface treatment plant 12. The segregated processing products 100 thus obtained in each case by the operator of the surface treatment plant 12 can then once again be disposed of in the landfill A or alternatively thermally utilised in the incineration plant B, the latter again likewise being able to be run by the operator of the surface treatment plant 12, in order to use the recovered energy in the operator's own plant.

Optionally, the segregated processing products 100 obtained can be brought together to form a mixed processing material 102 and disposed of as such jointly in the landfill A or passed on for thermal utilisation in the incineration plant B. The bringing-together of the segregated processing products 100 obtained can also be performed in the utilisation method IV, which is not specifically shown again.

Overall, through the processing and reutilisation strategy, an energy- and resource-saving material utilisation can take place. Even in the case of landfilling of the processing material 100, other materials can be processed therewith, and can thus be disposed of in an easier and more environmentally friendly manner.

1. Method for operating a surface treatment plant, comprising the steps of:
picking up overspray arising in one or more coating booths by an air stream;
guiding the overspray to one or more disposable separating units, in which the overspray is separated;
exchanging the one or more disposable separating units after reaching a limit loading with overspray, as laden disposable separating units, for an empty disposable separating unit,
wherein
a processing material is produced from laden disposable separating units, which material enables subsequent utilisation.

2. The method according to claim 1, wherein the processing material is produced in a processing plant which is associated with the surface treatment plant.

3. The method according to claim 1, wherein the processing material is produced in a processing plant which is not associated with the surface treatment plant.

4. The method according to claim 2, wherein the surface treatment plant comprises a plurality of coating booths, in which different kinds of overspray arise, and
a) laden disposable separating units (64) are jointly processed in the processing plant (70), irrespective of the kind of overspray with which they are laden;
or
b) laden filter modules which come from one and the same or from the same kind of coating booths are in each case jointly processed, so that the jointly processed filter modules are laden with overspray of the same kind and a segregated processing material based on the kind of overspray is obtained.

5. The method according to claim 4, wherein the processing is carried out according to step b) specified therein and different segregated processing products (100) are brought together to form a mixed processing material (102).

6. The method according to claim 1, wherein the processing material is passed on for thermal utilisation.

7. The method according to claim 6, wherein the thermal utilisation is performed by incinerating in an incineration plant (B).

8. The method according to claim 7, wherein the incineration plant (B) is associated with the surface treatment plant (12).

9. The method according to claim 6, wherein energy which is recovered in the thermal utilisation is used to operate the surface treatment plant and/or the processing plant.

10. The method according to claim 1, wherein in the production of the processing material from laden disposable separating units, one or more of the following steps are carried out:
a) drying of the laden separating units;
b) coarse comminuting or reducing in size of the laden separating units to form filter parts or filter packages;
c) shredding of the laden separating units or of filter parts or of filter packages to form coarse shredded material or to form fine shredded material;
d) admixing additives in one or more of the above steps a), b) or c).
